(19) United States
(12) Patent Application Publication
(10) Pub. No.: US 2024/0200632 A1
(43) Pub. Date: Jun. 20, 2024

(54) VIBRATION DAMPER FOR A VEHICLE

(71) Applicants: thyssenkrupp Bilstein GmbH, Ennepetal (DE); thyssenkrupp AG, Essen (DE)

(72) Inventors: Tim NORUSCHAT, Wuppertal (DE); Nicolas SUMKOETTER, Wadersloh (DE); Klaus SCHMIDT, Odenthal (DE)

(73) Assignees: thyssenkrupp Bilstein GmbH, Ennepetal (DE); thyssenkrupp AG, Essen (DE)

(21) Appl. No.: 18/538,928

(22) Filed: Dec. 13, 2023

(30) Foreign Application Priority Data
Dec. 16, 2022 (DE) 10 2022 133 666.2

(51) Int. Cl. F16F 9/32; F16F 9/18

(52) U.S. Cl. CPC F16F 9/3235; F16F 9/185; F16F 2222/12; F16F 2230/0041

(57) ABSTRACT

A vibration damper, for a vehicle, including an outer tube and an inner tube which is arranged coaxially with respect to the former, a compensation space for receiving hydraulic fluid being configured between the outer tube and the inner tube, and a working piston which is connected to a piston rod and is arranged such that it can be moved within the inner tube, the interior space of the inner tube being divided by way of the working piston into a first working space and a second working space, a plurality of flow elements which each have a pin-shaped region which extends in the radial direction being arranged within the compensation space.

### CROSS REFERENCE TO RELATED APPLICATION

This application is a U.S. Non-Provisional that claims priority to German Patent Application No. DE 10 2022 133 666.2, filed Dec. 16, 2022, and the entire content of which is incorporated herein by reference.

### FIELD

The disclosure relates to a vibration damper for a vehicle with a flow element for calming the flow within the vibration damper.

### BACKGROUND

In particular in the case of vibration dampers which are configured as multi-tube vibration dampers, it is known for apparatuses to be used for oil calming. Multi-tube vibration dampers usually do not have a separate gas space, with the result that the hydraulic oil and gas are not separated hermetically from one another. Piston rod movements or accelerations of the hydraulic fluid within the vibration damper therefore lead to relatively pronounced fluctuations in the hydraulic oil level. It is possible, for example, that the separation layer between oil and gas moves downwards on one side, in particular on the valve side, and therefore intensifies the foaming.

This frequently leads to “breaking up” of the hydraulic oil column, with the result that the hydraulic oil and the gas are mixed by way of foaming in such a way that gas passes into one of the working spaces. In a case of this type, the function of the vibration damper is highly restricted, and the required damping characteristic curve is no longer achieved.

It is known from the prior art for a spiral element to be used to calm the hydraulic oil. For example, DE 11 2019 006 471 TS has disclosed a vibration damper with a spiral element. The mounting of the spiral element within the vibration damper is problematic, however.

Thus, a need exists to provide a vibration damper for a vehicle, in the case of which vibration damper foaming of the hydraulic fluid is prevented reliably.

### BRIEF DESCRIPTION OF THE FIGURES

Further advantageous details, features and details of the disclosure will be explained in more detail in the context of the exemplary embodiments illustrated in the figures, in which:

FIG. 1 shows a cross-sectional view of a vibration damper with a plurality of flow elements in a longitudinal sectional view in accordance with one embodiment.

FIG. 2 shows a cross-sectional view of a vibration damper with a plurality of flow elements in a longitudinal sectional view in accordance with one exemplary embodiment.

FIG. 3 shows a cross-sectional view of a vibration damper with a plurality of flow elements in a longitudinal sectional view in accordance with a further exemplary embodiment.

FIG. 4 shows a perspective view of a central tube with a plurality of flow elements in accordance with a further exemplary embodiment.

FIG. 5 shows a cross-sectional view of a vibration damper with a plurality of flow elements in a longitudinal sectional view in accordance with a further exemplary embodiment.

FIG. 6 shows a central tube with a plurality of flow elements in a perspective view in accordance with a further exemplary embodiment.

FIG. 7 shows a diagram of a detail of a central tube with a plurality of flow elements in a perspective view in accordance with a further exemplary embodiment.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

In accordance with a first aspect, a vibration damper for a vehicle comprises an outer tube and an inner tube which is arranged coaxially with respect to the former, a compensation space for receiving hydraulic fluid being configured between the outer tube and the inner tube, and a working piston which is connected to a piston rod and is arranged such that it can be moved to and fro within the inner tube, the interior space of the inner tube being divided by way of the working piston into a first working space and a second working space. Furthermore, the vibration damper optionally has a central tube which is arranged within the compensation space and is fastened to the inner tube.

A plurality of flow elements which each have a pin-shaped region which extends in the radial direction are arranged within the compensation space.

The flow elements are preferably arranged in such a way that they in each case configure local flow resistances and, in particular, lower the kinetic energy of the hydraulic fluid which flows in the compensation space. The flow elements are preferably arranged in a labyrinthine manner within the compensation space, with the result that the hydraulic fluid has to take a labyrinthine flow path, in order to flow through the compensation space. The flow elements preferably bring about a local reduction in the flow speed of the hydraulic fluid, the hydraulic fluid being deflected multiple times, in particular.

The flow elements are preferably all of identical configuration. The flow elements optionally have different lengths. Flow elements with two different lengths are preferably arranged in the compensation space and, in particular, are arranged next to one another in an alternating manner. The flow elements preferably extend exclusively in the radial direction orthogonally with respect to the axial direction of the vibration damper. The extent is preferably to be understood to mean the orientation of the longitudinal axis of the flow element, in particular of the pin-shaped region. Each flow element preferably has a pin-shaped region. The pin-shaped region is, for example, of cylindrical or hollow-cylindrical configuration, and preferably has a round, polygonal, square, rectangular or elliptical cross section. The pin-shaped region preferably has a substantially constant diameter. The pin-shaped region is optionally of conical configuration. It is likewise conceivable that the flow elements are of pyramidal, conical, spherical, hemispherical, needle-shaped, cuboid, wedge-shaped, polygonal or filamentary configuration.

The vibration damper is preferably a multi-tube vibration damper, the compensation space being filled with a gas partially, in particular at the upper end. The outer tube preferably configures the housing of the vibration damper at least partially. The inner surface of the inner tube is preferably configured as a guide of the working piston. The working piston preferably has a valve device, by way of which the first and the second working space are connected to one another.

An annular space is preferably configured between the optional central tube and the inner tube. The inner tube has, in particular, at least one passage opening which fluidically connects the first, piston rod-side working space to the annular space, the passage opening being configured in the first working space.

The vibration damper has, in particular, a closure package which is configured and arranged to fluidically seal the interior space of the outer tube on the piston rod side. The piston rod-side end of the inner tube is preferably fastened to the closure package. Lying opposite the closure package, at the piston rod-remote end, the interior space of the outer tube is preferably sealed fluidically by means of a bottom piece. A bottom valve which, in particular, is attached to the piston rod-remote end of the inner tube is arranged on the bottom piece, in particular. The second working space is preferably connected fluidically via the bottom valve to the compensation space. The bottom valve is preferably a check valve which can be flowed through in both directions or only one direction. For example, the bottom valve is configured as a check valve in the rebound direction, in the case of a piston movement in the direction out of the inner tube, and is configured as a characteristic-generating valve in the compression direction, in the case of a piston movement into the inner tube.

The optional central tube is preferably arranged coaxially with respect to and between the inner tube and the outer tube. By way of example, the central tube has a length which corresponds approximately to from 40% to 90%, in particular to from 50% to 80% of the length of the inner tube. A central tube which is configured in this way can be produced inexpensively and makes simple and time-optimized assembly possible.

According to a first embodiment, the flow elements are fastened to the outer tube, the inner tube, the central tube, or to a tube element, the tube element being attached to the central tube. The tube element and the flow elements are preferably configured from a plastic or metal. In particular, the flow elements are configured in one piece or in one part with the tube element, the central tube or the outer tube. The flow elements are optionally fastened releasably to the tube element, the central tube or the outer tube, for example by means of a screw or plug-in connection. The flow elements are preferably attached to the tube element, the central tube or the outer tube by means of a positively locking, integrally joined and/or non-positive connection. The tube element preferably bears against the central tube or the outer tube, and is preferably connected fixedly thereto, for example by means of a positively locking connection or a snap-in connection. The tube element is preferably arranged coaxially with respect to the outer tube and the central tube.

In accordance with a further embodiment, at least some of the flow elements or all of the flow elements bear against the outer tube, the inner tube and/or the central tube. The flow elements preferably bear by way of the free, non-fastened end against the central tube or the outer tube. For example, half of the flow elements bear against the outer tube or the central tube, the remaining flow elements configuring a gap between the outer tube or the central tube. The flow elements preferably bear in a fluid-tight manner against the outer tube or the central tube, with the result that a flow of the hydraulic fluid is prevented.

In accordance with a further embodiment, the flow elements are arranged next to one another in such a way that a flow channel for conducting hydraulic fluid is configured between adjacent flow elements. The flow elements are preferably arranged, in particular, spaced apart uniformly from one another. The flow channels are preferably configured in such a way that the hydraulic fluid is deflected multiple times in the radial direction, axial direction and in the circumferential direction. As a result, a homogenization of the separation layer between oil and gas is preferably produced.

In accordance with a further embodiment, the pin-shaped regions of the flow elements are each arranged, in particular, spaced apart uniformly from one another. The pin-shaped regions of the flow elements are preferably connected releasably or fixedly to the tube element, the inner tube, the central tube and/or the outer tube, in particular in a positively locking, integrally joined and/or non-positive manner. The pin-shaped regions are preferably screwed to the central tube, the tube element or the outer tube.

In accordance with a further embodiment, the flow elements are arranged in axial rows, circumferential rows and/or spiral rows along the outer tube, the central tube or the tube element. In accordance with a further embodiment, adjacent flow elements are arranged offset axially and/or in the circumferential direction with respect to one another. For example, the spacing between two flow elements which are adjacent in the circumferential direction is greater than the spacing between two flow elements which are adjacent in the axial direction.

In accordance with a further embodiment, the flow elements each have a pin-shaped region and a head region which adjoins the pin-shaped region radially, in particular on the inside or on the outside. The head region is preferably connected fixedly to the pin-shaped region and is configured, for example, in one piece with the latter. In particular, the head region of the flow element bears in a fluid-tight manner against the inner side of the outer tube or the outer side of the central tube or is arranged spaced apart therefrom. The pin-shaped region is preferably connected releasably, for example screwed, to the head region. The head region is preferably of spherical configuration and has a greater diameter than the pin-shaped region.

In accordance with a further embodiment, the head region has a greater diameter than the pin-shaped region. The flow elements have, for example, a circular disc-shaped head region. The pin-shaped region and/or the head region are/is, for example, of pyramidal, conical, spherical, hemispherical, needle-shaped, cuboid, wedge-shaped, polygonal or filamentary configuration.

In accordance with a further embodiment, the head regions of flow elements which are adjacent with respect to one another bear against one another. In particular, the flow elements are arranged in such a way that the head regions of flow elements which are adjacent axially or in the circumferential direction make contact with one another. For example, the head regions of all flow elements which are adjacent with respect to one another bear against one another.

In accordance with a further embodiment, the inner tube, the central tube, the outer tube and/or the tube element have/has a surface area which has a degree of filling of flow elements of from 1% to 99%, in particular of from 5% to 95%, preferably of from 30% to 90%. The degree of filling is to be understood to mean the sum of the cross-sectional areas of the flow elements per surface, the surface being a part region of the surface to which the flow elements are attached, for example the outer surface of the central tube, the tube element or the outer tube.

In accordance with a further embodiment, the flow elements are fastened to a tube element, the tube element being attached by means of a locking device to the central tube or the inner tube.

The locking device is preferably a fixed connection which, at least in the axial and/or radial direction and/or in the circumferential direction, prevents a relative movement of the tube element and the central tube or the inner tube with respect to one another. The locking device is preferably arranged at the piston rod-side end of the central tube or the inner tube.

In accordance with a further embodiment, the locking device is configured as a positively locking connection. The locking device is preferably a snap fastener. A positively locking connection, in particular a snap fastener, provides a particularly simple possibility for fastening the tube element to the central tube, no tool being necessary, in particular. The locking device is preferably configured in such a way that it fixes the tube element on the central tube in the axial direction and/or in the circumferential direction.

In accordance with a further embodiment, the locking device comprises a plurality of clamping arms which are arranged circumferentially next to one another and configure one end of the tube element. The clamping arms are configured, for example, in such a way that they can be deformed in the radial direction, with the result that the cross section of the tube element is preferably increased or decreased by way of a deformation of the clamping arms. The deformation is preferably a reversible, elastic deformation. The clamping arms extend, for example, in the axial direction and are each spaced apart via a slot from an adjacent clamping arm in the circumferential direction. The clamping arms preferably extend parallel to one another. The tube element preferably has a plurality of axial slots which extend in the axial direction from that end of the tube element which points in the direction of the closure package.

In accordance with a further embodiment, the central tube is attached to the inner tube via a central tube attachment. The central tube is preferably attached to the inner tube via at least one central tube attachment, in particular via a first and a second central tube attachment. At least one central tube attachment is arranged at the piston rod-remote end of the central tube, a further central tube attachment being arranged, for example, at the piston rod-side end of the central tube. The central tube attachment is preferably configured in the central tube. The central tube attachment preferably comprises two radially inwardly circumferentially running constrictions, the diameter of the central tube being decreased in the region of the constrictions in such a way that the central tube bears against the inner tube. An annular widened portion is configured between the two constrictions, the diameter of the central tube being widened in the region of the widened portion to the previous diameter outside the constriction. The widened portion is preferably configured in such a way that it configures a closed annular space between the central tube and the inner tube. A sealing element, in particular a sealing ring, is arranged within the annular space, for example, which sealing element bears against the inner tube and the central tube and configures a fluid-tight seal between them. The central tube attachment preferably provides a seal of the central tube against the inner tube. The central tube attachment is configured, in particular, in such a way that it prevents a movement of the central tube in the radial direction relative to the inner tube. The central tube attachment preferably does not fix the central tube on the inner tube in the axial direction. In particular, the central tube is fixed in the axial direction and in the circumferential direction by way of the mounting of a valve on the flange region of the central tube.

The locking device is preferably attached to the central tube attachment. The locking device is preferably arranged on the piston rod-side central tube attachment and, with the latter, forms a positively locking connection, in particular. The locking device is preferably configured in such a way that it latches in on the central tube attachment and preferably fixes the tube element in the axial direction on the central tube. The clamping arm of the locking device is preferably configured in such a way that it interacts with the widened portion, configuring the annular space, of the central tube attachment and, in particular, configures a positively locking connection. In particular, the central tube attachment comprises two radially inwardly pointing circumferentially running constrictions in the central tube.

For example, the locking device is configured in such a way that it latches in on the central tube attachment. Latching in is understood to mean a radial reversible deformation of at least one clamping arm in the radial direction to the outside, which is followed by a radial reversible deformation of at least one clamping arm in the radial direction to the inside, the tube element being fixed in the axial direction. During the mounting of the tube element, it is preferably pushed onto the central tube from the closure package-side end of the latter until it latches in on the central tube attachment.

In accordance with a further embodiment, the vibration damper has a damping valve device, and the tube element has a flange region for attaching the damping valve device to the central tube. The flange region forms a receptacle for the damping valve device; in particular, the flange region forms a fluid inlet and/or fluid outlet of the damping valve device. In particular, the flange region connects the annular space to the damping valve device. The outer tube of the vibration damper preferably has an opening, flush with the flange region, for receiving the damping valve device, with the result that the damping valve device is connected fluidically to the compensation space. The flange region is configured, for example, in one piece with the central tube, and preferably has a circular cross section. The preferably tubular flange region extends in the radial direction to the outside from the central tube in the direction of the outer tube. The tube element preferably extends from the piston rod-side locking device of the central tube as far as the flange region. The tube element is preferably spaced apart in the axial direction from the flange region, and does not extend in the axial direction beyond the flange region, in particular. It is likewise conceivable that the tube element extends from the piston rod-side locking device of the central tube as far as beyond the flange region, the end region of the tube element preferably having a groove which runs in the axial direction and in which the flange region is arranged. For example, the tube element and/or the central tube are/is configured from a plastic and/or from a metal.

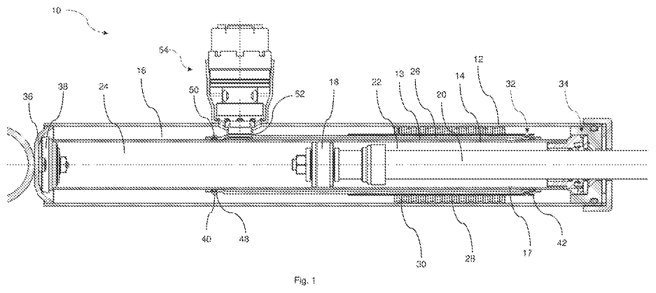

FIG. 1 shows a vibration damper 10, the vibration damper 10 being a multi-tube vibration damper, by way of example a two-tube vibration damper. The vibration damper 10 has an outer tube 12 which configures an outer surface, in particular a housing, of the vibration damper 10. An inner tube 14 is arranged within the outer tube 12 coaxially with respect to the latter. A compensation space 16 which is preferably filled at least partially with a hydraulic fluid is configured between the outer tube 12 and the inner tube 14. The compensation space 16 is preferably filled partially with a gas.

A working piston 18 which is connected to a piston rod 20 is arranged within the inner tube 14 in such a way that it can be moved within the inner tube 14, the inner tube preferably being configured as a guide of the working piston 18. The working piston 18 preferably has a valve device. The working piston 18 divides the interior space of the inner tube 14 into a first working space 22 which is arranged on the piston rod side, and a second working space 24 which is arranged remote from the piston rod. A central tube 26 is arranged within the compensation space 16 coaxially with respect to and between the inner tube 14 and the outer tube 12.

The interior space of the outer tube 12 is fluidically sealed on the piston rod side by means of a closure package 34. Lying opposite the closure package 34, at the piston rod-remote end, the interior space of the outer tube 12 is fluidically sealed by means of a bottom piece 36. A bottom valve 38 which, in particular, is attached at the piston rod-remote end of the inner tube 14 is arranged by way of example on the bottom piece 36. The bottom valve 38 is preferably a check valve which can be flowed through in both directions or only one direction. The second working space 24 is preferably connected fluidically via the bottom valve 38 to the compensation space 16. The piston rod-side end of the inner tube 14 is preferably fastened to the closure package 34.

The central tube 26 has by way of example a length which corresponds approximately to from 50 to 80% of the length of the inner tube 14. The central tube 26 is attached, in particular, to the inner tube 14 via a first and a second central tube attachment 40, 42. The first central tube attachment 40 is arranged at the piston rod-remote end of the central tube 26, and the second central tube attachment 42 is arranged at the piston rod-side end of the central tube 26.

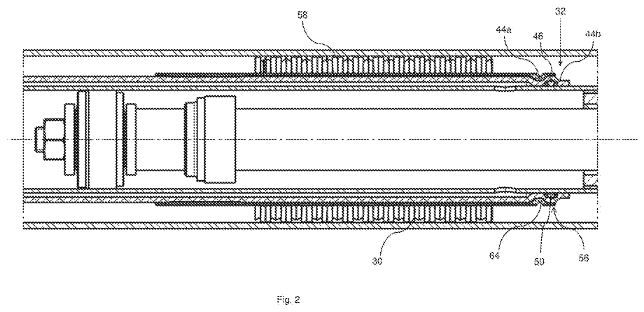

In the exemplary embodiment of FIGS. 1 and 2, a tube element 28 is arranged by way of example in the compensation space 16 and coaxially with respect to the central tube 26. The tube element 28 preferably bears against the outer surface of the central tube 26. A plurality of flow elements 30 are attached by way of example to the tube element 28.

The central tube attachment 40, 42 preferably comprises two radially inwardly circumferentially running constrictions 44a, b, the diameter of the central tube 26, in particular of the tube element 28, being reduced in the region of the constrictions 44a, b in such a way that the central tube 26, in particular the tube element 28, bears against the inner tube 14. The axially inward, first constriction 44a is adjoined by an, in particular, annular widened portion 46 of the inner tube 14, the diameter of the central tube 26, in particular of the tube element 28, being widened in the region of the widened portion 46 to the previous diameter outside the constriction 44. The widened portion 46 is adjoined in the axial direction to the outside by the second constriction 44b, which configures the end of the tube element 28. With the exception of the central tube attachment 40, 42, the central tube 26 preferably has a constant diameter and cross section. The widened portion 46 is preferably configured in such a way that it configures a closed annular space 48 between the central tube 26 and the inner tube 14. A sealing element, in particular a sealing ring 50, is arranged by way of example within the annular space 48, which sealing element bears against the inner tube 14 and the central tube 26 and configures a fluid-tight seal between them. The first and the second central tube attachment 40, 42 preferably each have an annular space 48 with a sealing ring 50. The widened portion 46 and constrictions 44a, b are preferably configured on the central tube 26.

An annular space 13 is configured between the central tube and the inner tube 14. At least one passage opening 17 which fluidically connects the first working space 22 to the annular space 13 is configured in the inner tube 14. The passage opening 17 is configured in the first working space 22.

The tube element 28 is preferably configured from a metal or a plastic. The central tube 26 has by way of example a flange region 52 for attaching a damping valve device 54 to the central tube 26. The flange region 52 is configured, for example, in one piece with the central tube 26 and preferably has a circular cross section. The preferably tubular flange region 52 extends in the radial direction outwards from the central tube 26 in the direction of the outer tube 12. The flange region 52 forms a receptacle for the damping valve 54; in particular, the flange region 52 forms a fluid inlet and/or fluid outlet of the damping valve device 54. The flange region 52 connects the annular space 13 to the damping valve device 54. The outer tube 12 preferably has an opening, flush with the flange region 52, for receiving the damping valve device 54, with the result that the damping valve device 54 is connected fluidically to the compensation space 16.

The flow elements 30 are preferably configured from a plastic. The flow elements 30 are preferably each configured as a radially outwardly pointing projection. The flow elements 30 preferably each have a pin-shaped region 58 which extends, in particular, exclusively in the radial direction to the outside. The extent is to be understood to mean the orientation of the longitudinal axis of the flow element 30, in particular of the pin-shaped region 58. The pin-shaped region 58 is, for example, of cylindrical or hollow-cylindrical configuration and preferably has a round, polygonal, square, rectangular or elliptical cross section. The pin-shaped region 58 preferably has a substantially constant diameter. The pin-shaped region 58 is optionally of conical configuration. It is likewise conceivable that the flow elements 30 are of pyramidal, conical, spherical, hemispherical, needle-shaped, cuboid, wedge-shaped, polygonal or filamentary configuration.

The flow elements 30 extend, for example, at least partially as far as the inner side of the outer tube 12 and, in particular, form a fluid-tight termination with the outer tube 12. At least some flow elements 30 are preferably arranged spaced apart from the inner side of the outer tube 12, with the result that a gap which is filled with hydraulic fluid is configured. The flow elements 30 are preferably arranged next to one another in such a way that a flow channel which is filled with hydraulic fluid is configured between adjacent flow elements. The pin-shaped regions 58 of the flow elements 30 are preferably each arranged spaced apart from one another uniformly. For example, flow elements 30 which are axially adjacent with respect to one another are arranged offset in the circumferential direction with respect to one another. The flow elements 30 are optionally arranged in axial rows or spiral rows along the central tube 26 or the tube element 28.

The flow elements 30 optionally have a pin-shaped region 58 and a head region 60 which adjoins it radially on the outside. The head region 60 is preferably connected fixedly to the pin-shaped region 58 and, for example, is configured in one piece with the latter. In particular, the head region 60 of the flow element 30 bears in a fluid-tight manner against the inner side of the outer tube 12 or is arranged spaced apart from the latter.

The tube element 28 is connected by way of example via a locking device 32 to the central tube 26. The locking device 32 is preferably configured in such a way that it prevents a relative movement of the tube element 28 with respect to the central tube 26 in the axial direction and/or in the circumferential direction. The locking device 32 is preferably configured at the piston rod-side end of the central tube 26, in particular on the piston rod-side central tube attachment 42. The locking device 32 is preferably a positively locking connection. The locking device 32 is preferably a snap fastener.

FIG. 2 shows the tube element 28 with the flow elements 30 according to FIG. 1 in detail. The tube element 28 has by way of example the locking device 32. That end region of the tube element 28 which points in the direction of the closure package 34 is preferably configured as a locking device 32. The locking device 32 is preferably configured in such a way that it configures a positively locking connection with the central tube attachment 42. The locking device 32 is preferably configured in such a way that it latches in on the central tube attachment 42 and preferably fixes the tube element 28 on the central tube 26 in the axial direction.

The locking device 32 comprises, for example, a plurality of clamping arms 56 which are arranged circumferentially next to one another and configure that end of the tube element 28 which points in the direction of the closure package 34. The clamping arms 56a-h extend, for example, in the axial direction parallel to one another and are preferably each separated via a slot which runs in the axial direction with respect to a clamping arm 56 which is adjacent in the circumferential direction. The tube element 28 has by way of example a plurality of clamping arms 56. The clamping arms 56 are, in particular, circumferential tube end portions of the tube element 28. The clamping arms 56 each have, in particular, a radially inwardly directed projection 64 which is configured in such a way that it interacts with the widened portion 46 of the central tube attachment 42 and, in particular, configures a positively locking connection. In particular, the projection 64 bears against the constriction 44a.

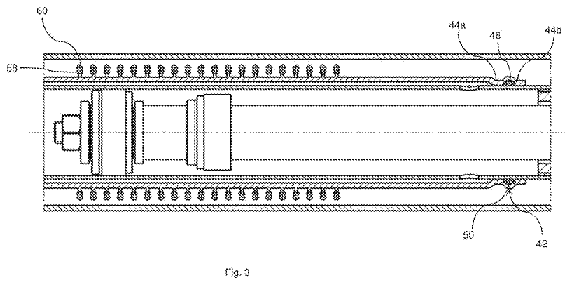

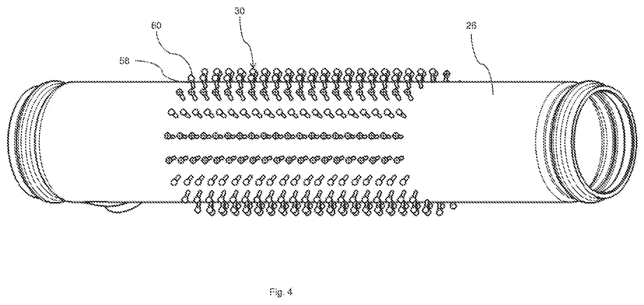

FIG. 3 shows a further exemplary embodiment of a vibration damper 10 with a plurality of flow elements 30. The flow elements 30 are by way of example fastened to the central tube 26 or are configured in one piece with the latter. The flow elements 30 by way of example each have a pin-shaped region 58 and a head region 60 which adjoins it radially to the outside. The pin-shaped region 58 is preferably connected releasably, for example screwed, to the head region 60. The head region is preferably of spherical configuration and has a greater diameter than the pin-shaped region 60. In the exemplary embodiment of FIGS. 3 and 4, the flow elements 30 are arranged by way of example in a plurality of axial rows, the spacing between two flow elements 30 which are adjacent in the circumferential direction being greater than the spacing between two flow elements 30 which are adjacent in the axial direction.

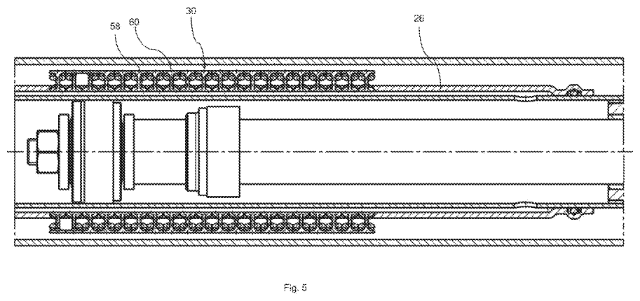

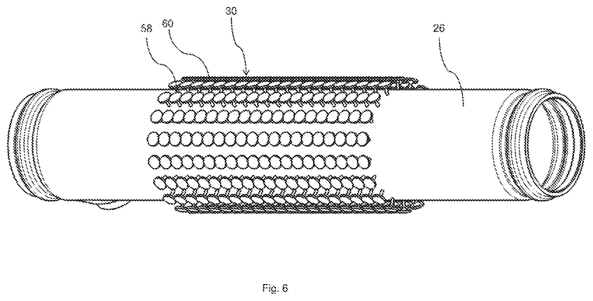

FIG. 5 and FIG. 6 show a further exemplary embodiment of a central tube 26 with flow elements 30. The flow elements 30 have by way of example a circular disc-shaped head region 60. The pin-shaped regions 58 are by way of example screwed to the central tube 26 and have, in particular, a circular cross section. The flow elements 30 are arranged in axial rows, the head regions 60 of axially adjacent flow elements 30 making contact with one another. All the flow elements 30 are by way of example of identical configuration. The flow elements 30 are preferably arranged spaced apart from the inner side of the outer tube 12, with the result that hydraulic fluid can flow between the outer tube 12 and the flow elements 30.

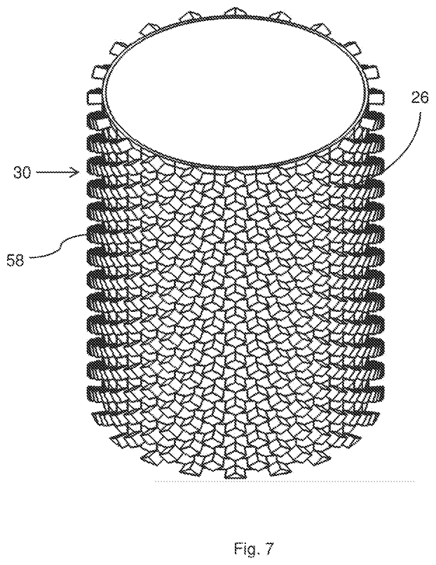

FIG. 7 shows a further exemplary embodiment of a detail of a central tube 26 or tube element 28 with a plurality of flow elements 30. The flow elements 30 have by way of example exclusively a pin-shaped region 58, the pin-shaped region 58 having, in particular, a polygonal, preferably square cross section. The flow elements 30 are configured by way of example as cuboids or cubes, and are preferably offset in each case with respect to one another in the circumferential direction and in the axial direction.

A plurality of flow elements 30 are preferably arranged on a defined surface of the tube element 28 or of the central tube 26. The degree of filling of flow elements 30 per unit area is preferably from 1% to 99%, in particular from 5% to 95%, preferably from 30% to 90%. The degree of filling is to be understood to mean the sum of the cross-sectional areas of the flow elements per surface, the surface being the surface, on which the flow elements 30 are attached, for example the outer surface of the central tube, the tube element or the outer tube.

What is claimed is:

1. A vibration damper, for a vehicle, comprising:
an outer tube and an inner tube arranged coaxially;
a compensation space for receiving hydraulic fluid located between the outer tube and the inner tube; and
a working piston which is connected to a piston rod and is arranged such that the working piston can be moved within the inner tube, wherein the interior space of the inner tube is divided by way of the working piston into a first working space and a second working space, wherein a plurality of flow elements, which each have a pin-shaped region which extends in the radial direction, are arranged within the compensation space.

2. The vibration damper of claim 1, wherein the flow elements being fastened to the outer tube, the inner tube, a central tube attached to the inner tube, or to a tube element, the tube element being attached to the inner tube, the central tube or the outer tube.

3. The vibration damper of claim 1, wherein at least some of the flow elements bear against the outer tube, the inner tube and/or the central tube.

4. The vibration damper of claim 1, wherein the flow elements are next to one another defining a flow channel for conducting hydraulic fluid is between adjacent flow elements.

5. The vibration damper of claim 1, wherein the pin-shaped regions of the flow elements are spaced apart uniformly from one another.

6. The vibration damper of claim 1, wherein the flow elements are arranged in axial rows, circumferential rows and/or spiral rows along the outer tube, the central tube or the tube element.

7. The vibration damper of claim 1, wherein adjacent flow elements are arranged offset axially and/or in the circumferential direction with respect to one another.

8. The vibration damper of claim 1, wherein the flow elements each having a pin-shaped region and a head region which adjoins the pin-shaped region radially.

9. The vibration damper of claim 8, wherein the head region has a greater diameter than the pin-shaped region.

10. The vibration damper of claim 8, wherein the head regions of flow elements which are adjacent with respect to one another bearing against one another.

11. The vibration damper of claim 1, wherein the inner tube, the central tube, the outer tube and/or the tube element have a surface area which has a degree of filling of flow elements of from 1% to 99%, in particular of from 5% to 95%, preferably of from 30% to 90%.

12. The vibration damper of claim 1, wherein the flow elements are fastened to a tube element and the tube element being attached by means of a locking device to the central tube or the inner tube.

13. The vibration damper of claim 12, wherein the locking device is a positively locking connection.

14. The vibration damper of claim 12, wherein the locking device includes a plurality of clamping arms arranged circumferentially next to one another and define an end of the tube element.

15. The vibration damper of claim 1, wherein the central tube is attached to the inner tube via a central tube attachment and the locking device is attached to the central tube attachment.

16. The vibration damper of claim 1, further comprising a damping valve device and the tube element having a flange region for attaching the damping valve device to the central tube.
